(19) United States
(12) Patent Application Publication
(10) Pub. No.: US 2015/0199159 A1
(43) Pub. Date: Jul. 16, 2015

(54) APPARATUS, SYSTEM, AND METHOD FOR PERSONALIZED MEDICATION LABELS

(71) Applicant: Xerox Corporation, Norwalk, CT (US)

(72) Inventors: Linn C. Hoover, Webster, NY (US); William J. Hannaway, Webster, NY (US); William J. Nowak, Webster, NY (US)

(73) Assignee: Xerox Corporation, Norwalk, CT (US)

(21) Appl. No.: 14/157,230

(22) Filed: Jan. 16, 2014

(51) Int. Cl. G06F 3/12; G06K 15/00; G06F 17/28; G08B 6/00; G06K 15/02; G06F 19/00

(52) U.S. Cl. CPC G06F 3/1243; G06K 15/024; G06F 3/1206; G06F 3/1257; G06F 19/326; G06F 19/322; G06F 17/289; G08B 6/00; G06K 15/4065; G06K 15/404

(57) ABSTRACT

A system including: a computer with a processor and a memory element; a printer; and a cutter. The memory is configured to store package configurations and label templates. Each label template includes respective data fields and a respective label size. The processor: receives prescription information including a medication, medication dosage, medication amount, and a schedule; selects a package configuration to accommodate the amount of the medication; selects first data fields suitable for accommodating the prescription information and a first label size compatible with the package configuration; selects a label template including the first data fields and label size; enters the prescription information in the first data fields; and transmits data, including the first label template with the prescription information entered in the first respective plurality of data fields to the printer. The printer prints the data on a sheet.

### TECHNICAL FIELD

The present disclosure relates to an apparatus, system, and method for automatically selecting appropriately sized package configurations and labels for a medication. The apparatus, system, and method automatically select a label template including data fields able to accept information related to the medication and the patient. The selected label template also includes a label size appropriate for the selected package configuration.

### BACKGROUND

Medication adherence, including patient adherence to medication regimens, is an important aspect of any system providing medical services. Specifically, lack of medication adherence has a negative effect on outcomes and increases costs associated with providing medical services. For example, research shows that:
1. Approximately 25% of patients prescribed medications for a new illness fail to fill their initial prescription;
2. Approximately half of patients taking maintenance medications for a chronic disease stop taking their medications within the first year, and,
3. The estimated cost of unnecessary medical treatment attributable to medication non-adherence is $290 billion annually.

Further, under the applicable laws and regulations, health care providers will be not be reimbursed for patients that are readmitted for the same chronic illness, such as congestive heart failure, within 30 days. Hospital admission data from 2009 shows 1.3 million Medicare patients were readmitted within 30 days based on drug events at an estimated cost of $12 billion. Other data indicates that one cause of repeat admissions is lack of adherence to medication regimens. Many of the reasons for the lack of adherence are related to problems with labeling of prescription medications. In general, the problems are related to inflexibility in the labeling process and include: illiteracy of the patient, the language used on the medication label (English typically) is not the primary language of the patient, and the size or configuration of the label is inadequate to enable inclusion of information necessary or helpful for the patient to understand and comply with the medication regimen.

Known medication packaging distribution channels use centralized distribution centers with minimum 12-24 hour turnaround times. Health care providers in hospitals often write or change patient prescriptions the day a patient is released, which does not allow enough time to provide the prescribed medication at the time of the patient's release.

### SUMMARY

According to aspects illustrated herein, there is provided a computer-based apparatus for labeling medications, including: a memory element for a computer configured to store a plurality of package configurations and a plurality of label templates, each label template in the plurality of label templates including a respective plurality of data fields and a respective label size; and a processor for the computer configured to receive prescription information including a name of a patient, a name of a medication, a dosage of the medication, an amount of the medication, and a schedule for taking the medication, select a first package configuration, from the plurality of package configurations, able to accommodate the amount of the medication, select a first respective plurality of data fields suitable for accommodating the prescription information and a first respective label size compatible with the first package configuration, select a label template from the plurality of label templates including the first respective plurality of data fields and the first respective label size, enter the prescription information in the first respective plurality of data fields and transmit first data, including the first label template with the prescription information entered in the first respective plurality of data fields.

According to aspects illustrated herein, there is provided a computer-based system for labeling medications, including: a computer with a processor and a memory element; a printer; and a two-dimensional cutter. The memory element is configured to store a plurality of package configurations and a plurality of label templates, each label template in the plurality of label templates including a respective plurality of data fields and a respective label size. The processor is configured to: receive prescription information including a name of a patient, a name of a medication, a dosage of the medication, an amount of the medication, and a schedule for taking the medication; select a first package configuration, from the plurality of package configurations, able to accommodate the amount of the medication; select a first respective plurality of data fields suitable for accommodating the prescription information and a first respective label size compatible with the first package configuration; select a label template from the plurality of label templates including the first respective plurality of data fields and the first respective label size; enter the prescription information in the first respective plurality of data fields; and transmit first data, including the first label template with the prescription information entered in the first respective plurality of data fields. The printer is configured to print the first data on a sheet. The two-dimensional cutter configured to cut the sheet to a size corresponding to the first respective label size.

According to aspects illustrated herein, there is provided a computer-based apparatus for labeling medications, including: a computer with a processor and a memory element configured to store a plurality of label templates each label template in the plurality of label templates including a respective plurality of data fields and a respective label size, each respective label size including second respective dimensions for a second area suitable for adhering to a surface of a package. The processor is configured to: receive prescription information including a name of a patient, a name of a medication, a dosage of the medication, an amount of the medication, and a schedule for taking the medication; receive a package configuration; select a first respective plurality of data fields suitable for accommodating the prescription information and a first respective label size compatible with the package configuration; select a label template from the plurality of label templates including the first respective plurality of data fields and the first respective label size; enter the prescription information in the first respective plurality of data fields; and transmit data, including the first label template with the prescription information entered in the first respective plurality of data fields.

According to aspects illustrated herein, there is provided a computer-based method for labeling medications, including: storing, in a memory element for a computer a plurality of package configurations and a plurality of label templates, each label template in the plurality of label templates including a respective plurality of data fields and a respective label size; receiving, using a processor for the computer, prescription information including a name of a patient, a name of a medication, a dosage of the medication, an amount of the medication, and a schedule for taking the medication; selecting, using the processor, a first package configuration, from the plurality of package configurations, able to accommodate the amount of the medication; selecting, using the processor a first respective plurality of data fields suitable for accommodating the prescription information and a first respective label size compatible with the first package configuration; selecting, using the processor, a first label template from the plurality of label templates including the first respective plurality of data fields and the first respective label size; entering, using the processor, the prescription information in the first respective plurality of data fields; and transmitting, using the processor, first data, including the first label template with the prescription information entered in the first respective plurality of data fields.

According to aspects illustrated herein, there is provided a computer-based method for labeling medications, including: storing, in a memory element for a computer a plurality of package configurations and a plurality of label templates, each label template in the plurality of label templates including a respective plurality of data fields and a respective label size; receiving, using a processor for the computer, prescription information including a name of a patient, a name of a medication, a dosage of the medication, an amount of the medication, and a schedule for taking the medication; selecting, using the processor, a first package configuration, from the plurality of package configurations, able to accommodate the amount of the medication; selecting, using the processor a first respective plurality of data fields suitable for accommodating the prescription information and a first respective label size compatible with the first package configuration; selecting, using the processor, a first label template from the plurality of label templates including the first respective plurality of data fields and the first respective label size; entering, using the processor, the prescription information in the first respective plurality of data fields; transmitting, using the processor, first data, including the first label template with the prescription information entered in the first respective plurality of data fields, to a printer and two-dimensional cutter, printing, using the printer, the first data on a sheet; and cutting the sheet to a size corresponding to the first respective label size using the two-dimensional cutter.

According to aspects illustrated herein, there is provided a computer-based method for labeling medications, including: storing, in a memory element for a computer, a plurality of label templates, each label template in the plurality of label templates including a respective plurality of data fields and a respective label size; receiving, using a processor for the computer, prescription information including a name of a patient, a name of a medication, a dosage of the medication, an amount of the medication, and a schedule for taking the medication; receiving, using the processor, a package configuration; selecting, using the processor a first respective plurality of data fields suitable for accommodating the prescription information and a first respective label size compatible with the package configuration; selecting, using the processor, a first label template from the plurality of label templates including the first respective plurality of data fields and the first respective label size; entering, using the processor, the prescription information in the first respective plurality of data fields; transmitting, using the processor, first data, including the first label template with the prescription information entered in the first respective plurality of data fields.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic block diagram of a computer-based apparatus for labeling medications;

FIG. 2 is a detail of the memory element of FIG. 1;

FIG. 3 is a detail of the processor of FIG. 1;

FIG. 4 is a schematic block diagram of a computer-based system for labeling medications;

FIG. 5 is a detail of the memory element of FIG. 4;

FIG. 6 is a detail of the processor of FIG. 4;

FIG. 7 is a schematic flow chart of a system including the apparatus of FIG. 1;

FIG. 8 is a schematic representation of data fields for an example label template;

FIG. 9 is an example label; and,

FIG. 10 is a representation of example tactile features.

### DETAILED DESCRIPTION

Moreover, although any methods, devices or materials similar or equivalent to those described herein can be used in the practice or testing of these embodiments, some embodiments of methods, devices, and materials are now described.

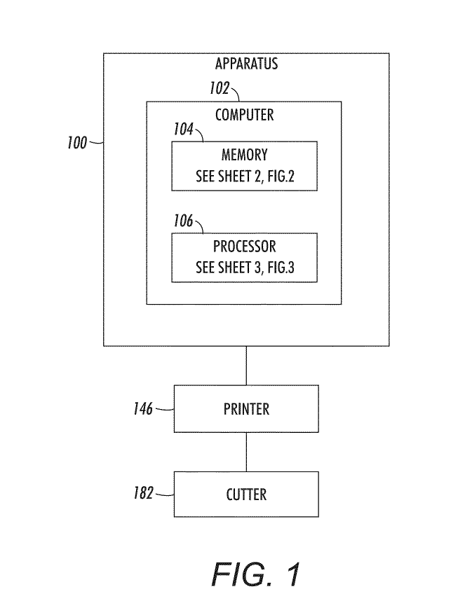

FIG. 1 is a schematic block diagram of computer-based apparatus 100 for labeling medications.

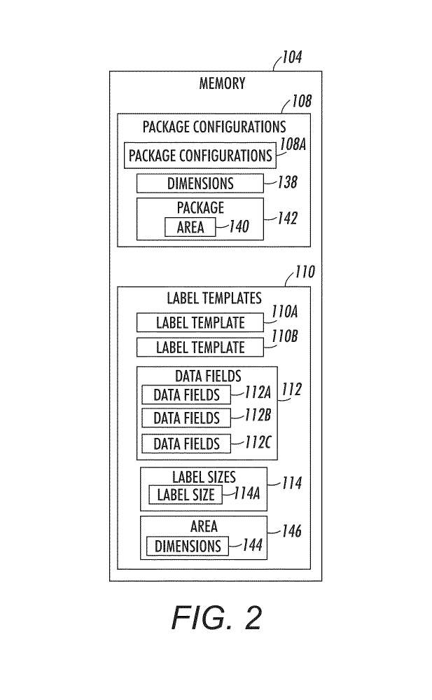

FIG. 2 is a detail of the memory element of FIG. 1

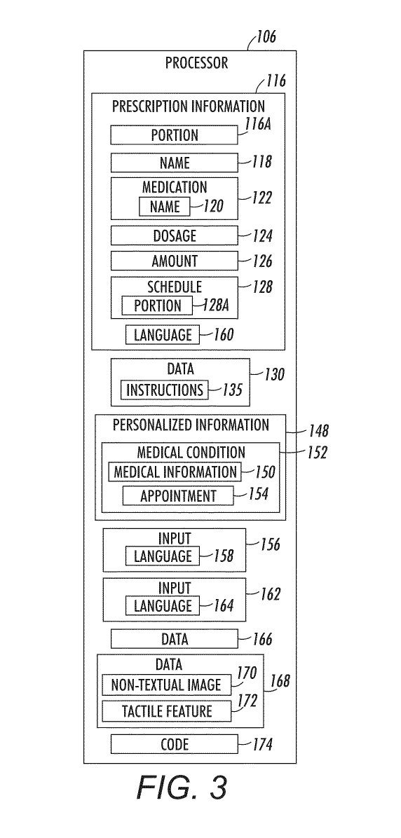

FIG. 3 is a detail of the processor of FIG. 1. The following should be viewed in light of FIGS. 1 through 3. Apparatus 100 includes computer 102 with memory element 104 and processor 106. The memory element is configured to store package configurations 108 and label templates 110. Configurations 108 can be any configurations known in the art and can selected to accommodate particular requirements of a user for system 100. Each label template 110 includes respective data fields 112 and respective label size 114. Processor 106 is configured to receive prescription information 116 including name 118 of a patient, name 120 of medication 122, dosage 124 of medication 122, amount 126 of medication 122, and schedule 128 for taking medication 122. For example, amount 126 could be a 30 day supply of pills or capsules at dosage 124. Processor 106 is configured to select package configuration 108A from package configurations 108, able to accommodate amount 126 of medication 122. For example, configuration 108A is large enough to accommodate a 30 day supply of pills or capsules at dosage 124. Processor 106 is configured to select data fields 112A suitable for accommodating prescription information 116, and label size 114A compatible with package configuration 108A. Processor 106 is configured to select label template 110A from label templates 110 including data fields 112A and label size 114A.

Processor 106 is configured to enter prescription information 116 in data fields 112A and transmit data 130 including label template 110A with prescription information 116 entered in data fields 112A.

In an example embodiment, apparatus 100 is configured to transmit data 130 to a printer, such as printer 132, and two-dimensional cutter, such as cutter 134. In an example embodiment, data 130 includes instructions 135 for printing the prescription information entered in data fields 112A on a sheet.

In an example embodiment, each package configuration 108 includes respective dimensions 138 for area 140 of a respective package 142. Area 140 defines an area of the package to which a label can be adhered. Each respective label size 114 includes respective dimensions 144 for area 146 suitable for adhering to a surface of a package. Processor 106 is configured to select label size 114A with area 146 able to fit within area 140. In an example embodiment, processor 106 is configured to select label size 114A with dimensions 144 substantially equal to dimensions 138.

In an example embodiment, processor 106 is configured to receive personalized information 148, specific to the patient and not included in prescription information 116 and select label template 110A to include data fields 112A or data fields 112B suitable for accommodating the personalized information. For example, the addition of information 148 may require more or different data fields. Hence, data fields 112A appropriate for information 116 alone may not be sufficient, requiring the selecting of different data fields (data fields 112B). Processor 106 is configured to enter personalized information 148 in data fields 112A or 112B and transmit data 130 including label template 110A with personalized information 148 entered in data fields 112A or 112B to the printer and two-dimensional cutter. In an example embodiment, personalized information 148 includes medical information 150 regarding medical condition 152 for the patient. Medical condition may or may not be directly related to medication 122. In an example embodiment, personalized information 148 includes appointment 154, for the patient, with a health care provider or a social services agency.

In an example embodiment, processor 106 is configured to receive input 156 electing language 158 and translate prescription information 116 to language 158. Processor 106 is configured to select data fields 112A suitable for accommodating translated prescription information 116, enter translated prescription information 116 in data fields 112A, and transmit data 130 including label template 1 OA, with translated prescription information 116 entered in data fields 112A.

In an example embodiment, processor 106 is configured to receive prescription information 116 in language 160 and select data fields 112A suitable for accommodating prescription information 116 in language 160. Processor 106 is also configured to receive input 162 selecting language 164 and translate prescription information 116 from language 160 to language 164. Processor 106 is further configured to select, as needed, data fields 112C, different from data fields 112A, suitable for accommodating prescription information 116 translated to language 164. Processor 106 is also configured to select label size 114B, different from label size 114A to accommodate data fields 112C.

Processor 106 is further configured to select label template 110B including data fields 112C and label size 114B, and transmit data 166, including label template 110B with prescription information 116 translated to language 164, entered in data fields 112B. Thus, apparatus 100 is configured to account for differences in the amount of room needed in data fields and labels for various languages to present the same information.

In an example embodiment, processor 106 is configured to create, using prescription information 116, data 168 representing at least a portion 116A of prescription information 116 as non-textual image 170 or tactile feature 172, and transmit data 168. In an example embodiment, portion 116A includes at least portion 128A of schedule 128 for taking medication 122.

In an example embodiment, the memory element is configured to store label templates 110 and the processor is configured to receive an input including a package configuration for medication 122.

In an example embodiment, apparatus 100 is in a same location as the printer and cutter. In an example embodiment, apparatus 100, and the printer and cutter are in different locations. Apparatus 100 and the printer and cutter can be under the control of the same entity or under the control of different respective entities. Thus, apparatus 100 can be operated as an internet service receiving input, such as information 116 from a remote source, such as a pharmacy, and providing data 130 to the remote source where the printer and cutter are located. In an example embodiment, apparatus 100 can interface with a plurality of remote sources to receive respective inputs and supply respective data.

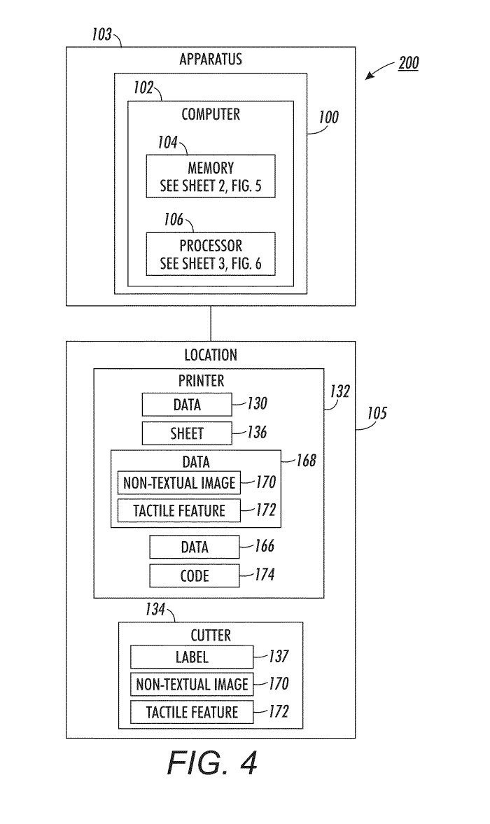

FIG. 4 is a schematic block diagram of computer-based system 100 for labeling medications.

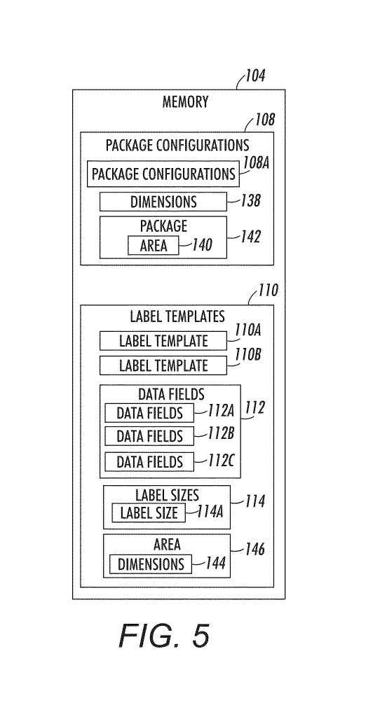

FIG. 5 is a detail of the memory element of FIG. 4

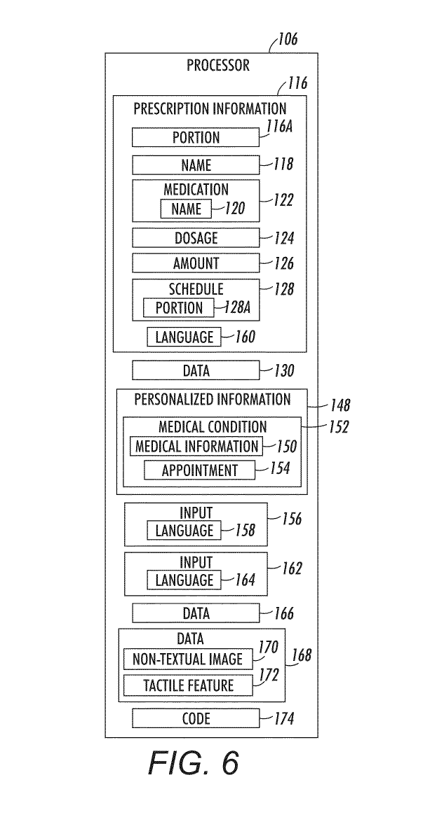

FIG. 6 is a detail of the processor of FIG. 1. The following should be viewed in light of FIGS. 1 through 6. System 200 includes apparatus 100 with computer 102 at location 103. The discussion regarding apparatus 100 is applicable to system 200 unless stated otherwise.

Processor 106 is configured to enter prescription information 116 in data fields 112A and transmit data 130 including label template 110A with prescription information 116 entered in data fields 112A. System 100 includes printer 132 in location 105. In an example embodiment system 200 includes two-dimensional cutter 134 in location 105. In an example embodiment, locations 103 and 105 are the same. In an example embodiment, locations 103 and 105 are different. Printer 132 and two-dimensional cutter 134 can be any printer or two-dimensional cutter, respectively, known in the art. Printer 132 is configured to receive data 130 and print data 130 on sheet 136. Cutter 134 is configured to cut label 137, from sheet 136, to a size corresponding to label size 114A.

In an example embodiment, processor 106 is configured to transmit data 130 including label template 110A, with translated prescription information 116 entered in data fields 112A, to the printer and two-dimensional cutter. In an example embodiment, the printer is configured to print data 166 on a sheet, for example, sheet 136 and the two-dimensional cutter is configured to cut the sheet to a size corresponding to label size 114B. Thus, system 200 is configured to account for differences in the amount of room needed in data fields and labels for various languages to present the same information.

In an example embodiment, the printer or the two-dimensional cutter is configured to print non-textual image 170 on sheet 136, or create tactile feature 172 on sheet 136. In an example embodiment, portion 116A includes at least portion 128A of schedule 128 for taking medication 122.

In an example embodiment, the printer is configured to integrate anti-counterfeiting technology into label 130.

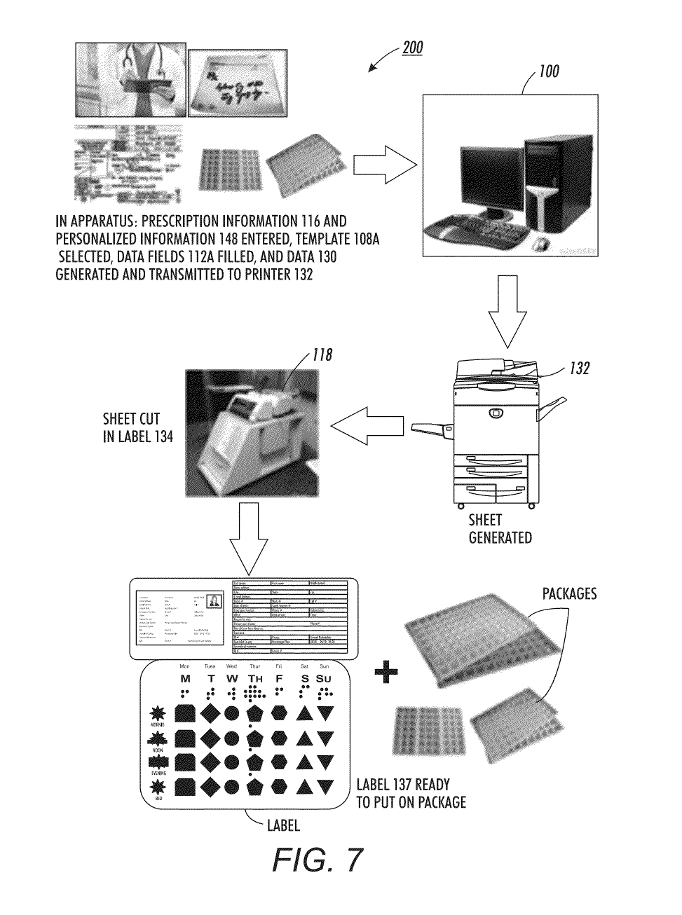

FIG. 7 is a schematic flow chart of system 200 including apparatus 100 of FIG. 1.

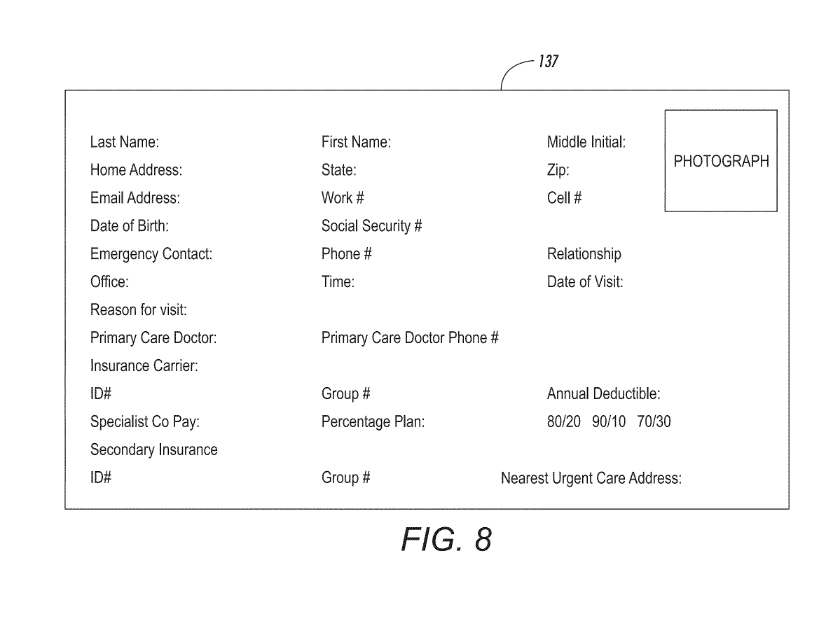

FIG. 8 is a schematic representation of data fields 112 for and example label template 110.

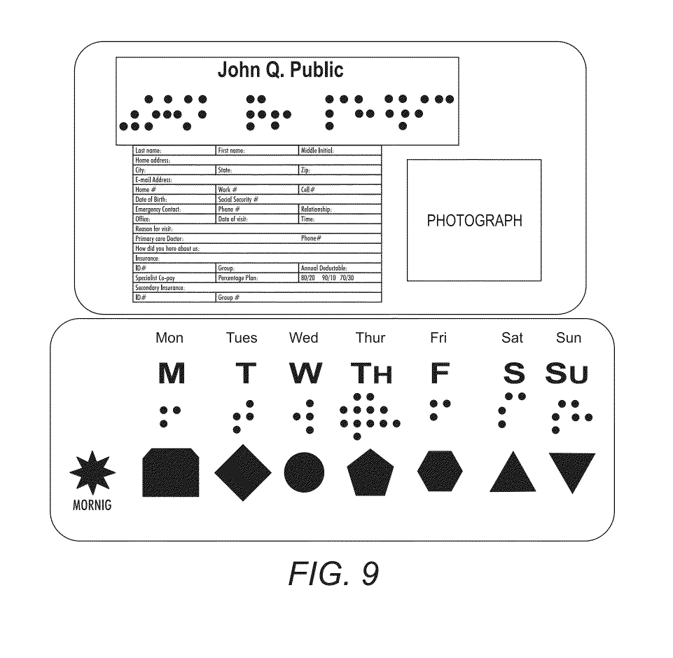

FIG. 9 is an example label 137. In FIG. 8, data fields 112 include: patient information such as name, address, and contact information; medical information; and insurance information. In FIG. 9, the information provided in data fields 112 is printed on label 137. Although particular data fields and printed information are shown in FIGS. 8 and 9, respectively, it should be understood that data fields 112 and the printed information are not restricted to the examples shown.

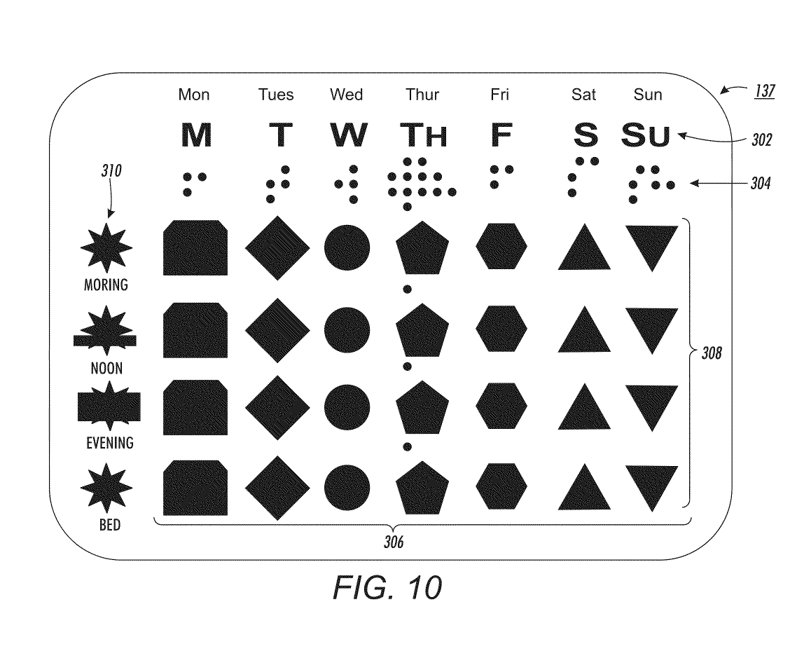

FIG. 10 is a representation of example tactile features available for use on labels. Row 302 illustrates enlarged text for days for the week for those with impaired vision for example. Row 304 illustrates Unified Braille representations for the days of the week. Columns 306 and rows 308 illustrate symbols for the days of the week. Column 310 illustrates symbols for times of day. Any combination of the features shown in FIG. 10 can be used on labels 137. It should be understood that tactile features 172 are not limited to the features shown in FIG. 10.

The discussion that follows is directed to apparatus 100, although is should be understood that the discussion is applicable to system 200 as well. Apparatus 100 enables the flexible functionality described above (create personalized medication packets) at a point of sale or point of distribution, such as a hospital pharmacy or other local pharmacy, and obviates the need to send prescription information to a remote location with the attendant delays and lack of flexibility. Apparatus 100 analyzes prescription information 116 entered by a pharmacist for example and automatically selects suitable medication package configuration 108 based on prescription information 116. Apparatus 100 then applies the patient and medication regimen information to label template 110 for selected package configuration 108. In system 200, the printer prints the label on a sheet of media and the cutter cuts the sheet to produce label size 114.

As noted above, the success of a patient's recovery is directly related to the ability of the patient adhere to a medication regimen, for example, to maintain uniform dosing of medications prescribed by hospital doctors prior to the patient's release. The increase in patient adherence to medication regimens facilitated by apparatus 100 enables health care facilities such as hospitals, critical care facilities and clinics to improve the probability that patients of the facilities successfully adhere to prescription regiments. The personalized medication packaging and labeling of apparatus 100 and system 200 benefits both patients and health care facilities and lowers the overall cost of health care by increasing patient adherence and reducing patient readmissions.

As noted above, health care providers in hospitals often write or change patient prescriptions the day a patient is released, which does not allow enough time to provide the prescribed medication at the time of the patient's release. Advantageously, apparatus 100 enables rapid generation of personalized medication labels at the hospital for fulfillment at the hospital pharmacy prior to the patient being discharged. In like manner, personalized medication labels can be generated at other points of sale easily accessible by the patient.

Apparatus 100 is not limited to specific packaging configurations. Apparatus 100 can be adapted to a wide variety of commercially available personalized medication packaging. In an example embodiment, apparatus 100 enables customizing package configurations 108 and/or label templates 110 to accept customer supplied packaging or trial samples from packaging vendors.

Dimensions 138 can be expanded to include internal dimensions for individual tray size and spacing between trays, enabling accommodation of all possible arrangement of existing pill packs available in the market worldwide.

In an example embodiment, the processor is configured to transmit scannable code 174 to a printer, and the printer adds code 174 to the label. Any scannable code known in the art, for example quick response (QR) codes can be used for code 174. For example, code 174 leads to additional information on the medication such as side effects and drug interactions. Code 174 also can offer a voluntary opt-in for coupons and future discounts and promotions. Code 174 also can enable purchase tracking capability beyond the prescription at hand.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based apparatus for labeling medications, comprising:
a memory element for a computer configured to store:
a plurality of package configurations; and,
a plurality of label templates, each label template in the plurality of label templates including a respective plurality of data fields and a respective label size; and,
a processor for the computer configured to:
receive prescription information including a name of a patient, a name of a medication, a dosage of the medication, an amount of the medication, and a schedule for taking the medication;
select a first package configuration, from the plurality of package configurations, able to accommodate the amount of the medication;
select:
a first respective plurality of data fields suitable for accommodating the prescription information; and,
a first respective label size compatible with the first package configuration;
select a label template from the plurality of label templates including the first respective plurality of data fields and the first respective label size;
enter the prescription information in the first respective plurality of data fields; and,
transmit first data, including the first label template with the prescription information entered in the first respective plurality of data fields, to a printer.

2. The computer-based apparatus of claim 1, wherein the first data includes instructions for printing the prescription information entered in the first respective plurality of data fields on a sheet.

3. The computer-based apparatus of claim 1, wherein:
each package configuration in the plurality of package configurations includes first respective dimensions for a first area of a respective package to which a label can be adhered;
each respective label size includes second respective dimensions for a second area suitable for adhering to a surface of a package; and,
selecting the first label template to include a respective label size compatible with the first package configuration includes selecting the second area to fit within the first area.

4. The computer-based apparatus of claim 1, wherein the processor is configured to:
receive personalized information, specific to the patient and not included in the prescription information, regarding the patient;
select the first label template to include a second respective plurality of data fields suitable for accommodating the personalized information;
enter the personalized information in the second respective plurality of data fields; and,
transmit the first data including the first label template with the personalized information entered in the second respective plurality of data fields, to the printer and two-dimensional cutter.

5. The computer-based apparatus of claim 4, wherein the personalized information includes medical information regarding a medical condition for the patient.

6. The computer-based apparatus of claim 4, wherein the personalized information includes an appointment, for the patient, with a health care provider or a social services agency.

7. The computer-based apparatus of claim 1, wherein the processor is configured to:
receive an input selecting a first language;
translate the prescription information to the first language;
select the first respective plurality of data fields suitable for accommodating the translated prescription information;
enter the translated prescription information in the first respective plurality of data fields; and,
transmit the first data including the first label template with the translated prescription information entered in the first respective plurality of data fields to the printer and two-dimensional cutter.

8. The computer-based apparatus of claim 1, wherein the processor is configured to:
receive the prescription information in a first language;
select the first respective plurality of data fields suitable for accommodating the prescription information in the first language;
receive using the processor, an input selecting a second language;
translate the prescription information from the first language to the second language;
select:
a second respective plurality of data fields, different from the first respective plurality of data fields, suitable for accommodating the prescription information translated to the second language;
a second respective label size different from the first respective label size; and,
a second label template, from the plurality of label templates, including the second respective plurality of data fields and the second respective label size;
enter the prescription information translated to the second language in the second respective plurality of data fields; and,
transmit second data, including the second label template with the prescription information, translated to the second language, entered in the second respective plurality of data fields, to the printer.

9. The computer-based apparatus of claim 1, wherein the processor is configured to:
create, using the prescription data, second data representing at least a portion of the prescription information as a non-textual image or a tactile feature; and,
transmit the second data to the printer.

10. The computer-based apparatus of claim 1, wherein the first data includes instructions for:
printing the non-textual image on the sheet; or,
creating the tactile feature on the sheet.

11. The computer-based apparatus of claim 10, wherein the at least a portion of the prescription information includes at least a portion of the schedule for taking the medication.

12. A computer-based system for labeling medications, comprising:
a computer with:
a memory element configured to store:
a plurality of package configurations; and,
a plurality of label templates, each label template in the plurality of label templates including a respective plurality of data fields and a respective label size;
a processor configured to:
receive prescription information including a name of a patient, a name of a medication, a dosage of the medication, an amount of the medication, and a schedule for taking the medication;
select a first package configuration, from the plurality of package configurations, able to accommodate the amount of the medication;
select:
a first respective plurality of data fields suitable for accommodating the prescription information; and,
a first respective label size compatible with the first package configuration;
select a label template from the plurality of label templates including the first respective plurality of data fields and the first respective label size;
enter the prescription information in the first respective plurality of data fields; and,
transmit first data, including the first label template with the prescription information entered in the first respective plurality of data fields; and,
a printer configured to print the first data on a sheet.

13. The computer-based system of claim 12, further comprising:
a two-dimensional cutter configured to cut the sheet to a size corresponding to the first respective label size.

14. The computer-based system of claim 13, wherein the processor is configured to:
create, using the prescription data, second data representing at least a portion of the prescription information as a non-textual image or a tactile feature; and,
transmit the second data to the printer or the two-dimensional cutter; and,
the printer or the two-dimensional cutter is configured to:
print the non-textual image on the sheet; or,
create the tactile feature on the sheet.

15. The computer-based system of claim 12, wherein:
each package configuration in the plurality of package configurations includes first respective dimensions for a first area of a respective package to which a label can be adhered;
each respective label size includes second respective dimensions for a second area suitable for adhering to a surface of a package; and,
selecting the first label template to include a respective label size compatible with the first package configuration includes selecting the second area to fit within the first area.

16. The computer-based system of claim 12, wherein the processor is configured to:
receive personalized information, specific to the patient and not included in the prescription information, regarding the patient, the personalized information including:
medical information regarding a medical condition for the patient; or,
an appointment, for the patient, with a health care provider or a social services agency;
select the first label template to include a second respective plurality of data fields suitable for accommodating the personalized information;
enter the personalized information in the second respective plurality of data fields; and,
transmit the first data including the first label template with the personalized information entered in the second respective plurality of data fields, to the printer.

17. The computer-based system of claim 12, wherein the processor is configured to:
receive an input selecting a first language;
translate the prescription information to the first language;
select the first respective plurality of data fields suitable for accommodating the translated prescription information;
enter the translated prescription information in the first respective plurality of data fields; and,
transmit the first data including the first label template with the translated prescription information entered in the first respective plurality of data fields to the printer.

18. A computer-based method for labeling medications, comprising:
storing, in a memory element for a computer:
a plurality of package configurations; and,
a plurality of label templates, each label template in the plurality of label templates including a respective plurality of data fields and a respective label size;
receiving, using a processor for the computer, prescription information including a name of a patient, a name of a medication, a dosage of the medication, an amount of the medication, and a schedule for taking the medication;
selecting, using the processor, a first package configuration, from the plurality of package configurations, able to accommodate the amount of the medication;
selecting, using the processor:
a first respective plurality of data fields suitable for accommodating the prescription information; and,
a first respective label size compatible with the first package configuration;
selecting, using the processor, a first label template from the plurality of label templates including the first respective plurality of data fields and the first respective label size;
entering, using the processor, the prescription information in the first respective plurality of data fields; and,
transmitting, using the processor, first data, including the first label template with the prescription information entered in the first respective plurality of data fields.

19. The computer-based method of claim 18, wherein:
each package configuration in the plurality of package configurations includes respective dimensions for a first area of a respective package to which a label can be adhered;
each respective label size includes respective dimensions for a second area suitable for adhering to a surface of a package; and,
selecting the first respective label size compatible with the first package configuration includes selecting the second area to substantially fit within the first area.

20. The computer-based method of claim 18, further comprising:
receiving, using the processor, personalized information specific to the patient and not included in the prescription information, wherein:
the personalized information includes:
medical information regarding a medical condition for the patient; or,
an appointment for the patient with a health care provider or a social services agency;
selecting the first respective plurality of data fields includes selecting the first respective plurality of data fields to accommodate the personalized information, the method further comprising:
entering, using the processor, the personalized information in the second respective plurality of data fields; and,
transmitting, using the processor, second data including the personalized information entered in the second respective plurality of data fields.

21. The computer-based method of claim 18, further comprising:
receiving, using the processor, an input selecting a first language; and,
translating, using the processor, the prescription information to the first language, wherein:
selecting the first respective plurality of data fields includes selecting the first respective plurality of data fields suitable for accommodating the translated prescription information;
entering the prescription information in the first respective plurality of data fields includes entering the translated prescription information in the first respective plurality of data fields; and,
transmitting the first data includes transmitting the first label template with the translated prescription information entered in the first respective plurality of data fields.

22. The computer-based method of claim 18, further comprising:
creating, using the processor and the prescription data, second data representing at least a portion of the prescription information as a non-textual image or a tactile feature; and,
transmitting, using the processor, the second data.

23. A computer-based method for labeling medications, comprising:
storing, in a memory element for a computer:
a plurality of package configurations; and,
a plurality of label templates, each label template in the plurality of label templates including a respective plurality of data fields and a respective label size;
receiving, using a processor for the computer, prescription information including a name of a patient, a name of a medication, a dosage of the medication, an amount of the medication, and a schedule for taking the medication;
selecting, using the processor, a first package configuration, from the plurality of package configurations, able to accommodate the amount of the medication;
selecting, using the processor:
a first respective plurality of data fields suitable for accommodating the prescription information; and,
a first respective label size compatible with the first package configuration;
selecting, using the processor, a first label template from the plurality of label templates including the first respective plurality of data fields and the first respective label size;
entering, using the processor, the prescription information in the first respective plurality of data fields;
transmitting, using the processor, first data, including the first label template with the prescription information entered in the first respective plurality of data fields, to a printer; and,
printing, using the printer, the first data on a sheet.

24. The computer-based method of claim 23, further comprising:
cutting the sheet to a size corresponding to the first respective label size using a two-dimensional cutter.

25. The computer-based method of claim 24, further comprising:
creating, using the processor and the prescription data, second data representing at least a portion of the prescription information as a non-textual image or a tactile feature;
transmitting, using the processor, the second data to the printer or the two-dimensional cutter, and,
creating, using the printer or the two-dimensional cutter:
the non-textual image on the sheet; or,
the tactile feature on the sheet.

26. The computer-based method of claim 23, wherein:
each package configuration in the plurality of package configurations includes respective dimensions for a first area of a respective package to which a label can be adhered;
each respective label size includes respective dimensions for a second area suitable for adhering to a surface of a package; and,
selecting the first respective label size compatible with the first package configuration includes selecting the second area to substantially fit within the first area.

27. The computer-based method of claim 23, further comprising:
receiving, using the processor, an input selecting a first language; and,
translating, using the processor, the prescription information to the first language, wherein:
selecting the first respective plurality of data fields includes selecting the first respective plurality of data fields suitable for accommodating the translated prescription information;
entering the prescription information in the first respective plurality of data fields includes entering the translated prescription information in the first respective plurality of data fields; and,
transmitting the first data includes transmitting the first label template with the translated prescription information entered in the first respective plurality of data fields.

28. A computer-based apparatus for labeling medications, comprising:
a memory element for a computer configured to store a plurality of label templates each label template in the plurality of label templates including:
a respective plurality of data fields; and,
a respective label size, each respective label size including second respective dimensions for a second area suitable for adhering to a surface of a package; and,
a processor configured to:
receive prescription information including a name of a patient, a name of a medication, a dosage of the medication, an amount of the medication, and a schedule for taking the medication;
receive a package configuration;
select:
a first respective plurality of data fields suitable for accommodating the prescription information; and,
a first respective label size compatible with the package configuration;
select a label template from the plurality of label templates including the first respective plurality of data fields and the first respective label size;
enter the prescription information in the first respective plurality of data fields; and,
transmit data, including the first label template with the prescription information entered in the first respective plurality of data fields.

29. A computer-based method for labeling medications, comprising:
storing, in a memory element for a computer, a plurality of label templates, each label template in the plurality of label templates including a respective plurality of data fields and a respective label size;
receiving, using a processor for the computer, prescription information including a name of a patient, a name of a medication, a dosage of the medication, an amount of the medication, and a schedule for taking the medication;
receiving, using the processor, a package configuration;
selecting, using the processor:
a first respective plurality of data fields suitable for accommodating the prescription information; and,
a first respective label size compatible with the package configuration;
selecting, using the processor, a first label template from the plurality of label templates including the first respective plurality of data fields and the first respective label size;
entering, using the processor, the prescription information in the first respective plurality of data fields; and,
transmitting, using the processor, first data, including the first label template with the prescription information entered in the first respective plurality of data fields.
